(19) United States
(12) Patent Application Publication
(10) Pub. No.: US 2025/0237810 A1
(43) Pub. Date: Jul. 24, 2025

(54) TUNABLE PHOTONIC COUPLERS FOR ELECTRONIC/PHOTONIC SYSTEMS AND METHODS OF FORMING THE SAME

(71) Applicant: Taiwan Semiconductor Manufacturing Company Limited, Hsinchu (TW)

(72) Inventors: Tso-Jung Chang, Taoyuan City (TW); Chih-Peng Lin, Hsinchu (TW); Jeng-Shien Hsieh, Kaohsiung (TW); Chieh-Yen Chen, Taipei City (TW); Chen-Hua YU, Hsinchu City (TW)

(21) Appl. No.: 18/421,102

(22) Filed: Jan. 24, 2024

(51) Int. Cl. G02B 6/122; G02B 6/12; G02B 6/13

(52) U.S. Cl. CPC G02B 6/122; G02B 6/13; G02B 2006/12147

(57) ABSTRACT

An embodiment photonic coupler may include a first input waveguide, a second input waveguide, a first output waveguide, a second output waveguide, a coupling region in which electromagnetic fields associated with two or more of the first input waveguide, the second input waveguide, the first output waveguide, and the second output waveguide are overlapping with one another, and an electro-optic device in the coupling region that includes an index of refraction that is a first function of an applied voltage. The coupling region may have an effective coupling length, along an optical propagation direction, which is a second function of a product of a physical length of the coupling region multiplied by the index of refraction of the electro-optic device. A mixing ratio of electromagnetic energy transferred between the input and output waveguides, due to evanescent coupling, may be controlled by adjusting the voltage applied to the photonic coupler.

### BACKGROUND

Many computing applications use optical (i.e., photonic) signals to provide secure high-speed data transmission. Various emerging technologies are also being developed that may provide functionality to perform computing operations directly on optical/photonic signals. Silicon photonics is a promising technology area that uses semiconductor device processing techniques to provide systems including integrated electronic and photonic components. Such components may be used for the generation, routing, modulation, processing, and detection of light. Together, these functions may form an optical analog to electronic integrated circuits (EIC) and, as such, may constitute photonic integrated circuits (PIC).

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic illustration of various components that may be used in a photonic computing system.

FIG. 2A is a top view of an electro-optic modulator that may be used in a photonic computing system.

FIG. 2B is a top view of an optical switch that may be used in a photonic computing system.

FIG. 2C is a vertical cross-sectional view of a dielectric waveguide along a vertical plane C-C′ in FIGS. 2A and 2B.

FIG. 3A is a top view of a photonic device including photonic couplers and photonic modulator portions, according to various embodiments.

FIG. 3B is a vertical cross-sectional view of a first modulator portion of the photonic device of FIG. 3A, according to various embodiments.

FIG. 3C is a vertical cross-sectional view of a first photonic coupler of the photonic device of FIG. 3A, according to various embodiments.

FIG. 4 is a top view of a further photonic device including photonic couplers and photonic modulator portions, according to various embodiments.

FIG. 5A is a vertical cross-sectional view of an alternative modulator portion that may be used in the photonic devices (300, 400) of FIGS. 3A and 4, according to various embodiments.

FIG. 5B is a vertical cross-sectional view of an alternative photonic coupler that may be used in the photonic devices (300, 400) of FIGS. 3A and 4, according to various embodiments.

FIG. 6A is a vertical cross-sectional view of a further alternative modulator portion of the photonic device of FIG. 3A, according to various embodiments.

FIG. 6B is a vertical cross-sectional view of a further alternative photonic coupler that may be used in the photonic devices (300, 400) of FIGS. 3A and 4, according to various embodiments.

FIG. 7A is a vertical cross-sectional view of an intermediate structure that may be used in the formation of a photonic coupler, according to various embodiments.

FIG. 7B is a vertical cross-sectional view of a further intermediate structure that may be used in the formation of a photonic coupler, according to various embodiments.

FIG. 7C is a vertical cross-sectional view of a further intermediate structure that may be used in the formation of a photonic coupler, according to various embodiments.

FIG. 7D is a vertical cross-sectional view of a further intermediate structure that may be used in the formation of a photonic coupler, according to various embodiments.

FIG. 7E is a vertical cross-sectional view of a further intermediate structure that may be used in the formation of a photonic coupler, according to various embodiments.

FIG. 7F is a vertical cross-sectional view of a further intermediate structure that may be used in the formation of a photonic coupler, according to various embodiments.

FIG. 7G is a vertical cross-sectional view of a further intermediate structure that may be used in the formation of a photonic coupler, according to various embodiments.

FIG. 7H is a vertical cross-sectional view of a further intermediate structure that may be used in the formation of a photonic coupler, according to various embodiments.

FIG. 7I is a vertical cross-sectional view of a further intermediate structure that may be used in the formation of a photonic coupler, according to various embodiments.

FIG. 7J is a vertical cross-sectional view of a further intermediate structure that may be used in the formation of a photonic coupler, according to various embodiments.

FIG. 7K is a vertical cross-sectional view of a further intermediate structure that may be used in the formation of a photonic coupler, according to various embodiments.

FIG. 7L is a vertical cross-sectional view of a photonic coupler, according to various embodiments.

FIG. 8 is a flowchart illustrating operations of a method of forming a photonic coupler, according to various embodiments.

### DETAILED DESCRIPTION

The following disclosure provides many different embodiments, or examples, for implementing unique features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. Unless explicitly stated otherwise, each element having the same reference numeral is presumed to have the same material composition and to have a thickness within a same thickness range.

An embodiment photonic coupler may be advantageous by providing an electro-optic device that allows an effective coupling length to be tuned based on a voltage that is applied to the electro-optic device. In this regard, the effective coupling length may determine a mixing ratio of first electromagnetic energy transferred from a first input waveguide to a second output waveguide relative to second electromagnetic energy transferred from a second input waveguide to a first output waveguide. For example, the embodiment photonic coupler may be designed to perform as a 50/50 beam splitter in the absence of an applied voltage, by designing the effective coupling length to be an integer multiple of a wavelength plus a quarter wavelength. Due to manufacturing tolerances, however, there may be imperfections in the photonic coupler that may lead to errors in the mixing ratio of transferred electromagnetic energy.

Thus, while designed as a 50/50 beam splitter, the photonic coupler may actually perform as a 49/51 beam splitter (or a 41/59 beam splitter, etc.), for example, due to imperfections. Various embodiment electro-optic devices may correct the mixing ratio with a suitably applied bias voltage. In this regard, the bias voltage may be used to correct the 49/51 performance (or other percentage error) to achieve the desired 50/50 beam splitter performance by tuning the voltage-dependent effective coupling length. In other embodiments, the electro-optic device may be used to achieve various other mixing ratios in other applications. As such, embodiment photonic couplers may allow errors in device performance to be easily corrected by adjusting the applied voltage.

An embodiment photonic coupler may include a first input waveguide, a second input waveguide, a first output waveguide, a second output waveguide, a coupling region in which electromagnetic fields associated with two or more of the first input waveguide, the second input waveguide, the first output waveguide, and the second output waveguide are overlapping with one another, and an electro-optic device in the coupling region that includes an index of refraction that is a first function of an applied voltage. The coupling region may have an effective coupling length, along an optical propagation direction, which is a second function of a product of a physical length of the coupling region multiplied by the index of refraction of the electro-optic device. A mixing ratio of electromagnetic energy transferred between the input and output waveguides, due to evanescent coupling, may be controlled by adjusting the voltage applied to the photonic coupler.

An embodiment photonic device may include a first input waveguide, a second input waveguide, a third input waveguide, a fourth input waveguide, a first output waveguide, a second output waveguide, a third output waveguide, a fourth output waveguide, a first photonic coupler, and a second photonic coupler. The first photonic coupler may mix a first input photonic signal, received from the first input waveguide, and a second input photonic signal, received from the second input waveguide, to generate a first output photonic signal and a second output photonic signal that are respectively provided to the first output waveguide and the second output waveguide.

The second photonic coupler may mix a third input photonic signal, received from the third input waveguide, and a fourth input photonic signal, received from the fourth input waveguide, to generate a third output photonic signal and a fourth output photonic signal that are respectively provided to the third output waveguide and the fourth output waveguide. A least one of the first photonic coupler and the second photonic coupler may include an electro-optic device that determines a mixing ratio of the first input photonic signal and the second input photonic signal, or of the third input photonic signal and the fourth input photonic signal, based on an applied voltage imposed on the first photonic coupler or the second photonic coupler, respectively.

An embodiment method of forming a photonic coupler may include forming a first input waveguide and a second input waveguide; forming a first output waveguide and a second output waveguide; and forming a coupling region including an electro-optic device that has an index of refraction that is a function of an applied voltage. As such, within the coupling region electromagnetic fields associated with two or more of the first input waveguide, the second input waveguide, the first output waveguide, and the second output waveguide may be overlapping with one another. The method may further include forming a first coupling waveguide segment that is optically coupled to the first input waveguide and to the first output waveguide; and forming a second coupling waveguide segment that is optically coupled to the second input waveguide and the second output waveguide, such that each of the first coupling waveguide segment and the second coupling waveguide segment are formed as part of the electro-optic device. The method may further include forming the coupling region to include forming a first terminal comprising n-type polysilicon; forming a second terminal comprising p-type silicon; and forming a dielectric layer separating the first terminal from the second terminal, such that a voltage difference applied between the first terminal and the second terminal causes a change in the effective index of refraction of the photonic coupler.

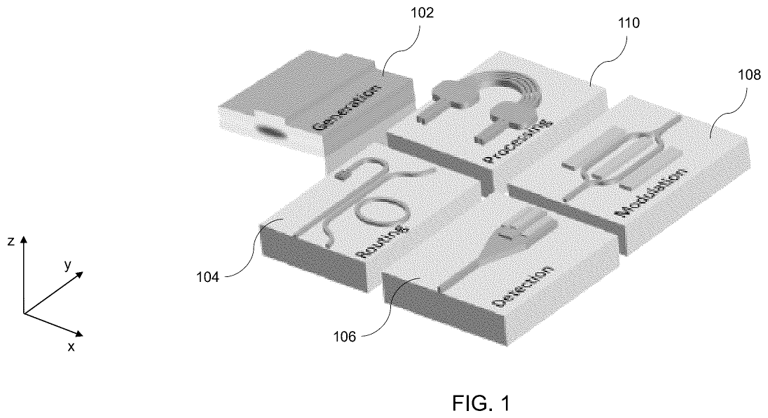

FIG. 1 is an illustration of various components that may be used in a photonic computing system. System components may include a generation device, also referred to as a photonic source 102, such as a laser or light-emitting diode (LED), a routing device that may include a plurality of dielectric waveguides 104 configured to route optical/photonic signals, and a detector that may include one or more optical/photonic detectors 106 configured to detect optical/photonic signals and to convert received optical/photonic signals into output electrical signals. Additional components may include a modulation device that may include one or more optical modulators 108 and photonic processing components 110.

The one or more optical modulators 108 may be configured to impose an amplitude and/or phase modulation on an input photonic signal generated by the photonic source 102. The photonic processing components 110 may be configured to perform logic operations on the modulated optical signal. The one or more optical modulators 108 may receive an input electronic signal and may modulate the input optical signal to impose an amplitude and/or phase modulation in response to the input electronic signal. In this way, the one or more optical modulators 108 may be used to convert data provided in the form of an electronic signal into data encoded as a photonic signal. Similarly, the one or more optical detectors 106 may convert processed photonic signals back into output electrical signals.

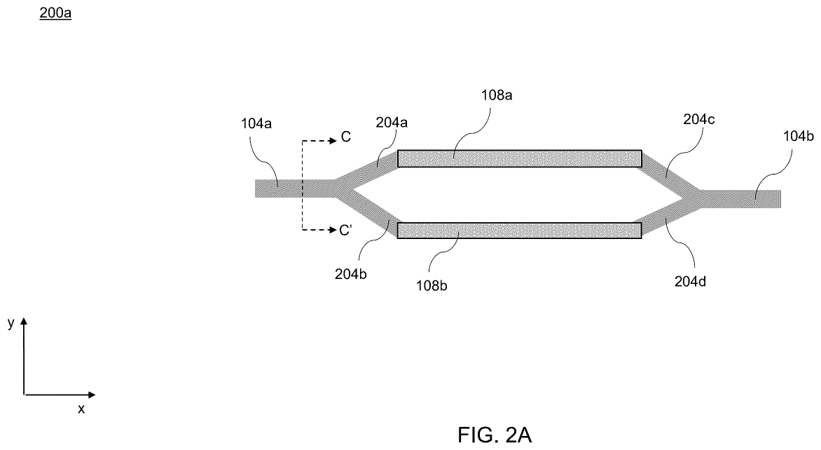

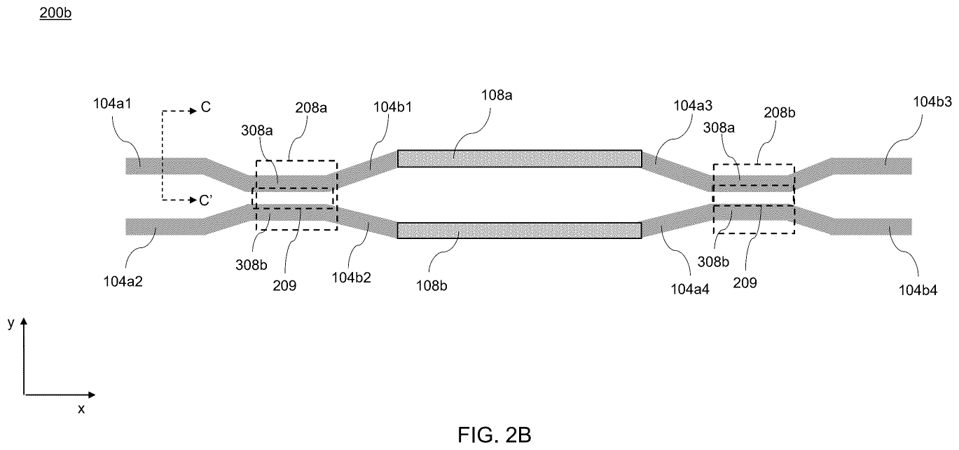

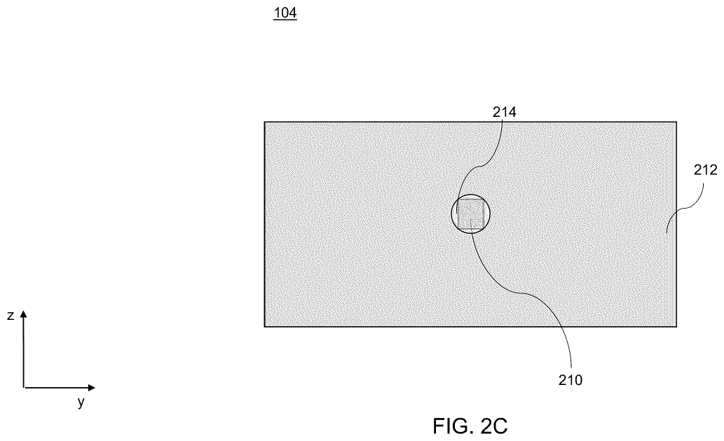

FIG. 2A is a top view of an electro-optic modulator 200a that may be used in a photonic computing system. The cross-section C-C′ indicates a vertical plane defining the vertical cross-sectional view shown in FIG. 2C. The electro-optic modulator 200a may include an input waveguide 104a and an output waveguide 104b. The input waveguide 104a may be configured to receive an input optical signal and the output waveguide 104b may be configured to provide an output optical signal that is a modulated version of the input optical signal. As shown, the input waveguide 104a may branch into a first waveguide segment 204a and a second waveguide segment 204b. As such, the input waveguide 104a, the first waveguide segment 204a, and the second waveguide segment 204b may act as a beam splitter.

An input signal received by the input waveguide 104a may be split into two optical signals (i.e., two copies of the input optical signal) that may be carried by the first waveguide segment 204a and the second waveguide segment 204b, respectively. A first optical signal carried by the first waveguide segment 204a may be provided to a first modulator portion 108a and a second optical signal carried by the second waveguide segment 204b may be provided to a second modulator portion 108b. The first modulator portion 108a and the second modulator portion 108b may modify an amplitude and/or a phase of the respective first optical signal and the second optical signal.

The modified first optical signal may be transmitted along a third waveguide segment 204c and the modified second optical signal may be transmitted along a fourth waveguide segment 204d. The modified first optical signal and the modified second optical signal may then be combined to form an output optical signal that is provided to the output waveguide 104b. In this regard, the third waveguide segment 204c may be optically coupled to the first modulator portion 108a, and the fourth waveguide segment 204d may be optically coupled to the second modulator portion 108b. In turn, the third waveguide segment 204c and the fourth waveguide segment 204d may be optically coupled to the output waveguide 104b. As such, the third waveguide segment 204c, the fourth waveguide segment 204d, and the output waveguide 104b may act as a beam combiner.

The first modulator portion 108a and the second modulator portion 108b may each modulate the respective first optical signal and the second optical signal according to an electro-optic effect. In this regard, the first modulator portion 108a and the second modulator portion 108b may each include a material having electro-optic properties. Such an electro-optic material may have optical properties (e.g., index of refraction and absorption coefficient) that may vary as a function of an applied electrical bias (i.e., voltage difference).

FIG. 2B is a top view of an optical switch 200b that may be used in a photonic computing system. The cross-section C-C′ indicates a vertical plane defining the vertical cross-sectional view shown in FIG. 2C. In an example embodiment, the optical switch 200b may be implemented as a Mach-Zehnder interferometer integrated with a first photonic coupler 208a (e.g., a first 50/50 beam splitter) and a second photonic coupler 208b (e.g., a second 50/50 beam splitter). Each of the first photonic coupler 208a and the second photonic coupler 208b may be referred to as a directional coupler or as a photonic coupler.

The optical switch 200b may include a first input waveguide 104a1 and a second input waveguide 104a2 that may each provide respective input signals to the first photonic coupler 208a. The first photonic coupler 208a may provide respective output signals to a first output waveguide 104b1 and a second output waveguide 104b2. Each of the first input waveguide 104a1, the second input waveguide 104a2, the first output waveguide 104b1, and the second output waveguide 104b2 may be configured to support single mode or multimode optical beams carrying optical signals.

The first photonic coupler 208a may receive a first optical signal from the first input waveguide 104a1 and a second input signal from the second input waveguide 104a2. Through the phenomena of evanescent coupling, within a coupling region 209, a first 50% of the first optical signal may be directed into the first output waveguide 104b1 and a second 50% of the first optical signal may be directed to the second output waveguide 104b2. Concurrently, a first 50% of the second optical signal may be directed into the first output waveguide 104b1 and a second 50% of the second optical signal may be directed to the second output waveguide 104b2. As such, the first optical signal and the second optical signal may be evenly split between the first output waveguide 104b1 and the second output waveguide 104b2.

As shown in FIG. 2B, the first photonic coupler 208a may include first coupling waveguide segment 308a that is optically coupled to the first input waveguide 104a1 and to the first output waveguide 104b1, and a second coupling waveguide segment 308b that is optically coupled to the second input waveguide 104a2 and the second output waveguide 104b2. The evanescent coupling occurs when the first coupling waveguide segment 308a and the second coupling waveguide segment 308b are sufficiently close to one another to thereby allow overlap of electric fields associates with the respective first coupling waveguide segment 308a and the second coupling waveguide segment 308b. The second photonic coupler 208b may also include similar structures (e.g., a first coupling waveguide segment 308a and a second coupling waveguide segment 308b).

The first modulator portion 108a and the second modulator portion 108b may receive signals from the first output waveguide 104b1 and the second output waveguide 104b2, respectively, and may act to adjust amplitudes and/or phases of the received signals. In this regard, each of the first modulator portion 108a and the second modulator portion 108b may include an electro-optic material having optical properties (e.g., index of refraction and absorption coefficient) that may vary as a function of an applied electrical bias. As such, in certain embodiments, phases of optical signals propagating with the first modulator portion 108a and the second modulator portion 108b may be controllably varied through application of pre-determined bias potentials.

After propagation through the first photonic coupler 208a, signals propagating in the first output waveguide 104b1 and the second output waveguide 104b2 may have a well-defined phase relationship (e.g., in-phase, 180° out-of-phase, etc.) relative to one another. As such, the first modulator portion 108a and the second modulator portion 108b may introduce a pre-determined phase difference between signals respectively received from the first output waveguide 104b1 and the second output waveguide 104b2. Signals propagating through the first modulator portion 108a may then be provided to a third input waveguide 104a3 and signals propagating through the second modulator portion 108b may be provided to a fourth input waveguide 104a4. Respective signals received from the third input waveguide 104a3 and the fourth input waveguide 104a4 may then be provided to the second photonic coupler 208b.

The second photonic coupler 208b may then act to send a first 50% of the signal received from the third input waveguide 104a3 to the third output waveguide 104b3 and a second 50% of the signal received from the third input waveguide 104a3 to the fourth output waveguide 104b4. Concurrently, a first 50% of the signal received from the fourth input waveguide 104a4 may be sent to the third output waveguide 104b3 and a second 50% of the signal received from the fourth input waveguide 104a4 may be sent to the fourth output waveguide 104b4. Each of the third input waveguide 104a3, the fourth input waveguide 104a4, the third output waveguide 104b3, and the fourth output waveguide 104b4 may be configured to support single mode or multimode optical beams carrying optical signals.

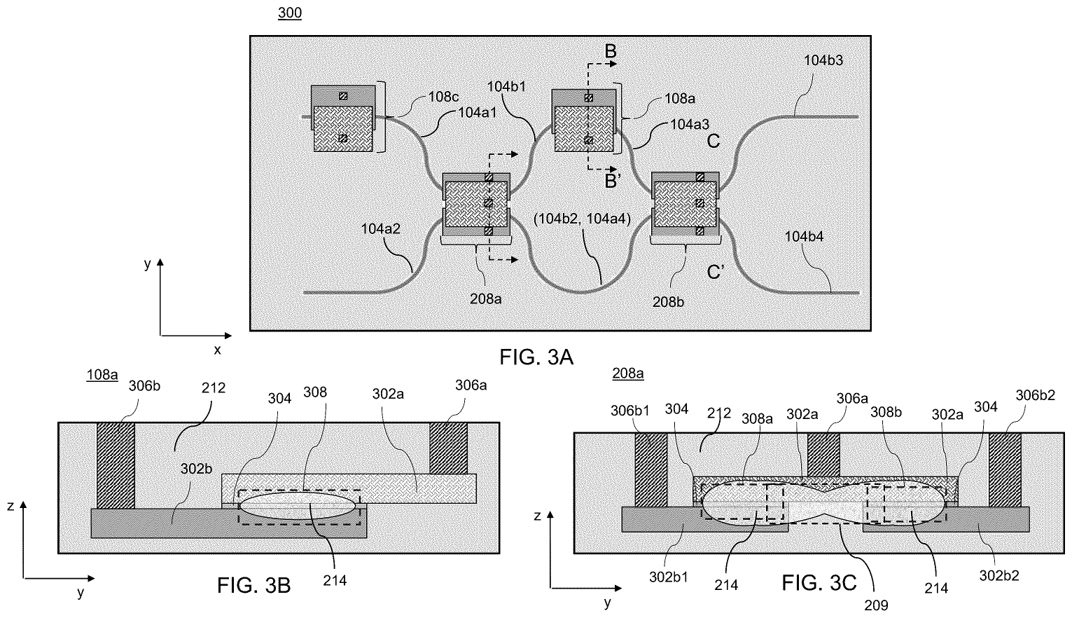

The relative phase between the signals propagating in the third input waveguide 104a3 and the fourth input waveguide 104a4 may determine what signals appear in the third output waveguide 104b3 and the fourth output waveguide 104b4. Due to the phenomena of constructive and destructive interference, signals may be switched such that a signal only appears in the third output waveguide 104b3 (e.g., light beams may be in-phase) or in fourth output waveguide 104b4 (e.g., light beams may be out of phase). As such, by applying certain predetermined bias voltages to the first modulator portion 108a and the second modulator portion 108b, the optical switch 200b may provide a switch functionality, in that optical signals may be directed to either the third output waveguide 104b3 or to the fourth output waveguide 104b4 as a function of bias voltages applied to the first modulator portion 108a and the second modulator portion 108b. Although both arms of the optical switch 200b (configured as a Mach-Zehnder interferometer in this example embodiment) are illustrated as including phase adjustment sections (i.e., the first modulator portion 108a and the second modulator portion 108b) other embodiments may include an optical switch 200b having a phase adjustment device in only a single arm, as described in greater detail with reference to FIG. 3A, below.

Although a Mach-Zehnder interferometer implementation is illustrated in FIG. 2B as the optical switch 200b, embodiments may not be limited to this particular switch architecture. Various other phase adjustment devices may be included within the scope of this disclosure, including ring resonator designs, Mach-Zehnder modulators, generalized Mach-Zehnder modulators, etc. In some embodiments, photonic modulators (108a, 108b) devices described herein may be utilized within a quantum computing system. Alternatively, such photonic modulators (108a, 108b) devices may be used in other types of optical systems. For example, other computational, communication, and/or technological systems may utilize photonic modulators (108a, 108b) devices to direct optical signals (e.g., single photons or continuous wave (CW) optical signals) within a system or network, and photonic devices described herein may be used within these systems, in various embodiments.

FIG. 2C is a vertical cross-sectional view of a dielectric (e.g., silicon/SiO₂) waveguide 104. As mentioned above, the vertical plane defining the view illustrated in FIG. 2C is indicated by the cross-section C-C′ in FIGS. 2A and 2B. The dielectric waveguide 104 may include a core portion 210 and a cladding portion 212. The core portion 210 and the cladding portion 212 may each be configured to be transparent to light of a particular wavelength (e.g., infrared radiation). The core portion 210 and the cladding portion 212 may be formed using semiconductor device fabrication processes, as described in greater detail below.

The core portion 210 may be configured to have a higher index of refraction than that of the cladding portion 212. For example, the core portion 210 may be formed of doped or undoped silicon (e.g., having index of refraction 3.88) and the cladding portion 212 may be formed of silicon oxide (e.g., having index of refraction 1.46). Optical/photonic signals may propagate preferentially in the core portion 210 due to the phenomena of total internal reflection resulting from the higher index of refraction of the core portion 210 relative to the cladding portion 212. For example, an optical mode may propagate within the core portion 210 and may have an electromagnetic field distribution 214 that is confined to a localized region associated with the core portion 210. The specific shape of the core portion 210 shown in FIG. 2C is merely an example and the core portion 210 may have various other shapes in other embodiments.

FIG. 3A is a top view of a photonic device 300 including photonic couplers (208a, 208b) and photonic modulator portions (108a, 108c), according to various embodiments. FIG. 3B is a vertical cross-sectional view of a first modulator portion 108a of the photonic device 300 of FIG. 3A, and FIG. 3C is a vertical cross-sectional view of a first photonic coupler 208a of the photonic device 300 of FIG. 3A, according to various embodiments. The cross-section B-B′ in FIG. 3A indicates a first vertical plane defining the vertical cross-sectional view shown in FIG. 3B and the cross-section C-C′ in FIG. 3A indicates a second vertical plane defining the vertical cross-sectional view shown in FIG. 3C.

As shown in FIG. 3A, the photonic device 300 may include a first input waveguide 104a1, a second input waveguide 104a2, a third input waveguide 104a3, and a fourth input waveguide 104a4. Similarly, the photonic device 300 may include a first output waveguide 104b1, a second output waveguide 104b2, a third output waveguide 104b3, and a fourth output waveguide 104b4. The photonic device 300 may further include a first photonic coupler 208a that mixes a first input photonic signal received from the first input waveguide 104a1 and a second input photonic signal received from the second input waveguide 104a2 to generate a first output photonic signal and a second output photonic signal that are respectively provided to the first output waveguide 104b1 and the second output waveguide 104b2.

The photonic device 300 may further include a second photonic coupler 208b that mixes a third input photonic signal received from the third input waveguide 104a3 and a fourth input photonic signal received from the fourth input waveguide 104a4 to generate a third output photonic signal and a fourth output photonic signal that are respectively provided to the third output waveguide 104b3 and the fourth output waveguide 104b4. The photonic device 300 may be similar to the optical switch 200b of FIG. 2B. In this regard, the photonic device 300 may further include a first modulator portion 108a that may act to change a first amplitude or phase of the first output photonic signal, received from the first output waveguide 104b1, and to generate the third input photonic signal that is provided to the third input waveguide 104a3.

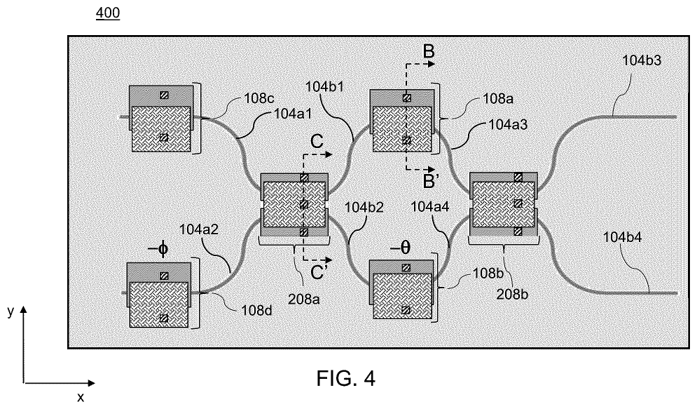

In contrast to the optical switch 200b of FIG. 2B, however, the photonic device 300 may omit the second modulator portion 108b that is located between the second output waveguide 104b2 and the fourth input waveguide 104a4 of FIG. 2B. In this regard, the second output waveguide 104b2 may be photonically coupled to the fourth input waveguide 104a4, for example, by providing a single waveguide (104b2, 104a4) that photonically couples the first photonic coupler 208a to the second photonic coupler 208b, as shown in FIG. 3A. Also, in contrast to the optical switch 200b of FIG. 2B, the photonic device 300 may include a third modulator portion 108c that may control an amplitude or phase of the first phonic signal provided by the first input waveguide 104a1. Various other configurations of photonic devices (e.g., photonic device 400) may be provided in other embodiments, as described with reference to FIGS. 4 to 6B, below.

As shown in FIG. 3B, the first modulator portion 108a may be configured as a semiconductor-insulator-capacitor structure. In this regard, the first modulator portion 108a may include a first terminal 302a including a first semiconductor material doped with first-conductivity-type dopant, and a second terminal 302b including a second semiconductor material doped with a second-conductivity-type dopant. The first modulator portion 108a may further include a dielectric layer 304 separating the first terminal 302a from the second terminal 302b. According to various embodiments, the first terminal 302a may be formed of n-type polysilicon, the second terminal 302b may include p-type silicon, and the dielectric layer 304 include silicon oxide. As shown in FIG. 3B, the first terminal 302a may be electrically connected to a first electrical contact 306a and the second terminal 302b may be electrically connected to a second electrical contact 306b.

Each of the first terminal 302a, the second terminal 302b, and the dielectric layer 304 may have a slab geometry extending along a length direction (i.e., the x-direction into the plane of the figure), a width direction (i.e., along the y-direction), and a thickness direction (i.e., along the z-direction). As shown in FIG. 3A, the first output waveguide 104b1 and the third input waveguide 104a3 may be optically coupled to the first modulator portion 108a. In this regard, the first modulator portion 108a may include an overlap region 308 in which the first terminal 302a, the second terminal 302b, and the dielectric layer 304 are overlapping in a plan view along a thickness direction (i.e., along the z-direction). As such, the overlap region 308 may form a coupling waveguide segment 308 that may optically couple the first output waveguide 104b1 and the third input waveguide 104a3. In this regard, the first output waveguide 104b1 may extend out of the plane of the figure along the x-direction and the third input waveguide 104a3 may extend into the plane of the figure along the x-direction.

The coupling waveguide segment 308 (i.e., overlap region 308) may support an optical mode propagating in the length direction (i.e., along the z-direction into the plane of the figure). As shown in FIG. 3B, the optical mode may have an electromagnetic field distribution 214 that spatially overlaps with the first terminal 302a, the second terminal 302b, and the dielectric layer 304. As such, electromagnetic fields may be photonically coupled from the first output waveguide 104b1, through the coupling waveguide segment 308, and into the third input waveguide 104a3.

The first modulator portion 108a may be configured as an electro-optic device that may modify an amplitude or phase of the electromagnetic field distribution 214. As such, an effective index of refraction and absorption coefficient of the first modulator portion 108a may be a function of an applied voltage difference between the first terminal 302a and the second terminal 302b. In this regard, the first terminal 302a, the second terminal 302b, and the dielectric layer 304 may form an electrically tunable capacitor structure having a p-n junction.

According to the free carrier dispersion effect in silicon, the optical properties of the coupling waveguide segment 308 may be changed by altering the carrier distribution within the first terminal 302a and the second terminal 302b by an applied bias. For example, in forward bias, carriers may be injected into the p-n junction reducing a size of a depletion region. In reverse bias, carriers may be depleted thereby increasing the size of the depletion region. In one configuration, the first modulator portion 108a may be operated in reverse bias (i.e., depletion mode) to have a low concentration of free carriers such that the coupling waveguide segment 308 exhibits relatively low optical absorption. In other embodiments, the first modulator portion 108a may be operated in forward bias.

As shown in FIG. 3C, the first photonic coupler 208a may also include an electro-optic device that may exhibit an index of refraction and absorption coefficient that may be a function of an applied bias. In this regard, the first photonic coupler 208a may include a first terminal 302a having a first slab geometry extending along the length direction (i.e., the x-direction into the plane of the figure), the width direction (i.e., the y-direction), and the thickness direction (i.e., the z-direction). The first photonic coupler 208a may further include a second terminal (302b1, 302b2) having a first segment 302b1 and a second segment 302b2. The first segment 302b1 and the second segment 302b2 may be disconnected from one another as shown. Each of the first segment 302b1 and the second segment 302b2 may have a second slab geometry extending along the length direction (i.e., the x-direction into the plane), the width direction (i.e., the y-direction), and the thickness direction (i.e., the z-direction). Further, as shown, the first segment 302b1 and the second segment 302b2 may be separated from one another along the width direction. The first photonic coupler 208a may further include a dielectric layer 304 separating the first terminal 302a from the second terminal (302b1, 302b2).

As with the first modulator portion 108a of FIG. 3B, the first photonic coupler 208a may be configured as a semiconductor-insulator-capacitor structure. A such, the first terminal 302a may include a first semiconductor material doped with first-conductivity-type dopant and the second terminal (302b1, 302b2) may include a second semiconductor material doped with a second-conductivity-type dopant. According to various embodiments, the first terminal 302a may be formed of n-type polysilicon, the second terminal (302b1, 302b2) may include p-type silicon, and the dielectric layer 304 include silicon oxide. As shown in FIG. 3C, the first terminal 302a may be electrically connected to a first electrical contact 306a, the first segment 302b1 of the second terminal (302b1, 302b2) may be electrically connected to a second electrical contact 306b1, and the second segment 302b2 of the second terminal (302b1, 302b2) may be electrically connected to a third electrical contact 306b2.

The first photonic coupler 208a may further include a first coupling waveguide segment 308a that is optically coupled to the first input waveguide 104a1 and to the first output waveguide 104b1, and a second coupling waveguide segment 308b that is optically coupled to the second input waveguide 104a2 and the second output waveguide 104b2 (e.g., see FIG. 2B). In this regard, the first input waveguide 104a1 may extend out of the plane of the figure of FIG. 3C along the x-direction and the first output waveguide 104b1 may extend into the plane of the figure along the x-direction. Similarly, the second input waveguide 104a2 may extend out of the plane of the figure of FIG. 3C along the x-direction and the second output waveguide 104b2 may extend into the plane of the figure along the x-direction.

The first coupling waveguide segment 308a (see FIGS. 2B and 3C) may extend along a length direction (i.e., along the x-direction into the plane of FIG. 3C), which may be parallel to an optical propagation direction. The first coupling waveguide segment 308a may be formed as a first overlap region 308a in which the first terminal 302a, the first segment 302b1 of the second terminal (302b1, 302b2), and the dielectric layer 304 are overlapping in a plan view along a thickness direction (i.e., along the z-direction). Similarly, the second coupling waveguide segment 308b may extend along the length direction (i.e., along the x-direction into the plane of FIG. 3C) and may be formed as a second overlap region 308b in which the first terminal 302a, the second segment 302b2 of the second terminal (302b1, 302b2), and the dielectric layer 304 are overlapping in a plan view along a thickness direction (i.e., along the z-direction). Further, as shown in FIG. 3C, the first segment 302b1 and the second segment 302b2 of the second terminal (302b1, 302b2) may be separated from one another along the width direction (i.e., along the y-direction).

The first photonic coupler 208a may receive a first optical signal from the first input waveguide 104a1 and a second input signal from the second input waveguide 104a2. Through the phenomena of evanescent coupling, electromagnetic fields associated with two or more of the first input waveguide 104a1, the second input waveguide 104a2, the first output waveguide 104b1, and the second output waveguide 104b2 may have an electromagnetic field distribution 214 that is spatially overlapping. As such, within a coupling region 209 (e.g., see FIGS. 2B and 3C) that includes the first overlap region 308a and the second overlap region 308b, electromagnetic energy associated with each of the first input waveguide 104a1, the second input waveguide 104a2, the first output waveguide 104b1, and the second output waveguide 104b2 may be coupled into one another. Accordingly, in various embodiments, the photonic device 300 may be configured as a first 50/50 beam splitter, for example, by designing a coupling length to be an integer multiple of a wavelength plus a quarter wavelength.

As described above with reference to FIG. 2B, when the photonic device 300 of FIG. 3A is configured as a first 50/50 beam splitter, a first 50% of the first optical signal may be directed into the first output waveguide 104b1 and a second 50% of the first optical signal may be directed to the second output waveguide 104b2. Concurrently, a first 50% of the second optical signal may be directed into the first output waveguide 104b1 and a second 50% of the second optical signal may be directed to the second output waveguide 104b2. In this regard, the first optical signal and the second optical signal may be evenly split between the first output waveguide 104b1 and the second output waveguide 104b2.

In general, the photonic device 300 may be configured to couple a different mixing ration of electromagnetic energy between the first input waveguide 104a1, the second input waveguide 104a2, the first output waveguide 104b1, and the second output waveguide 104b2. In this regard, the amount of electromagnetic energy coupled between the first input waveguide 104a1 and the second output waveguide 104b2 (and similarly for energy coupled between the second input waveguide 104a2 and the first output waveguide 104b1) depends on an effective coupling length of the coupling region 209 (i.e., an effective length along the propagation direction of the first overlap region 308a and the second overlap region 308b). In this regard, a mixing ratio of energy coupled between the various input and output waveguides is an oscillatory function (e.g., a sinusoidal function) of the effective coupling length.

For a fixed value of an effective index of refraction of the first photonic coupler 208a, the physical length of the first overlap region 308a and the second overlap region 308b determines the coupling length. Similarly, for a fixed length of the first overlap region 308a and the second overlap region 308b, the effective index of refraction of the first photonic coupler 208a determines the effective coupling length. As such, the effective coupling length is given by a product of the physical length and the effective index of refraction of the coupling region 209.

The effective coupling length of the first photonic coupler 208a may be configured to be a function of an applied voltage. In this regard, for a fixed physical length of the first overlap region 308a and the second overlap region 308b, the effective index of refraction may be varied, as described above with reference to FIG. 3B. As such, the effective coupling length may be varied as a function of an applied voltage bias between the first terminal 302a and the second terminal (302b1, 302b2). For example, a first percentage of a first electromagnetic energy may be coupled from the first input waveguide 104a1 into the second output waveguide 104b2 and a second percentage of a second electromagnetic energy may be coupled from the second input waveguide 104a2 into the first output waveguide 104b1, such that the first percentage of the first electromagnetic energy and the second percentage of the second electromagnetic energy are functions of the applied voltage. For example, according to an embodiment, the first percentage and the second percentage may each be between 49% and 51%. Various other voltage-tunable percentages may be achieved in other embodiments. In certain embodiments with high symmetry, the first and second percentages may be the same. Due to manufacturing tolerances, however, the first and second percentages need not be the same.

In general, the effective coupling length may be increased when the applied voltage has a first polarity and may be decreased when the applied voltage has a second polarity that is opposite to the first polarity. Thus, the first photonic coupler 208a may be configured such that a give range of applied voltages (e.g., negative to positive, positive to positive, or negative to negative) produces a corresponding range of mixing ratios of electromagnetic energy that is coupled between the first input waveguide 104a1, the second input waveguide 104a2, the first output waveguide 104b1, and the second output waveguide 104b2. The second photonic coupler 208b may be configured similarly to the first photonic coupler 208a. As such, the second photonic coupler 208b may also include an electro-optic device that determines a mixing ratio the third input photonic signal, received from the third input waveguide 104a3, and the fourth input photonic signal, received from the fourth input waveguide 104a4, based on an applied voltage imposed on the second photonic coupler 208b.

FIG. 4 is a top view of a further photonic device 400 including photonic couplers (208a, 208b) and photonic modulator portions (108a, 108b, 108c, 108d), according to various embodiments. The photonic device 400 may be similar to the photonic device 300 but may further include a second modulator portion 108b. As described above with reference to FIG. 2B, the second modulator portion 108b may be photonically connected between the second output waveguide 104b2 and the fourth input waveguide 104a4. As such, the second modulator portion 108b may change an amplitude or phase of the second output photonic signal, received by from the second output waveguide 104b2, to generate the fourth input photonic signal that is provided to the fourth output waveguide 104b4. Also, in contrast to the photonic device 300 of FIG. 3A, the photonic device 400 of FIG. 4 may include a fourth modulator portion 108d. As shown, the fourth modulator portion 108d may be configured to control an amplitude and/or phase of a second input signal provided by the second input waveguide 104a2. Each of the second modulator portion 108b and the fourth modulator portion 108d may include an electro-optic device, as described above with reference to FIG. 3B.

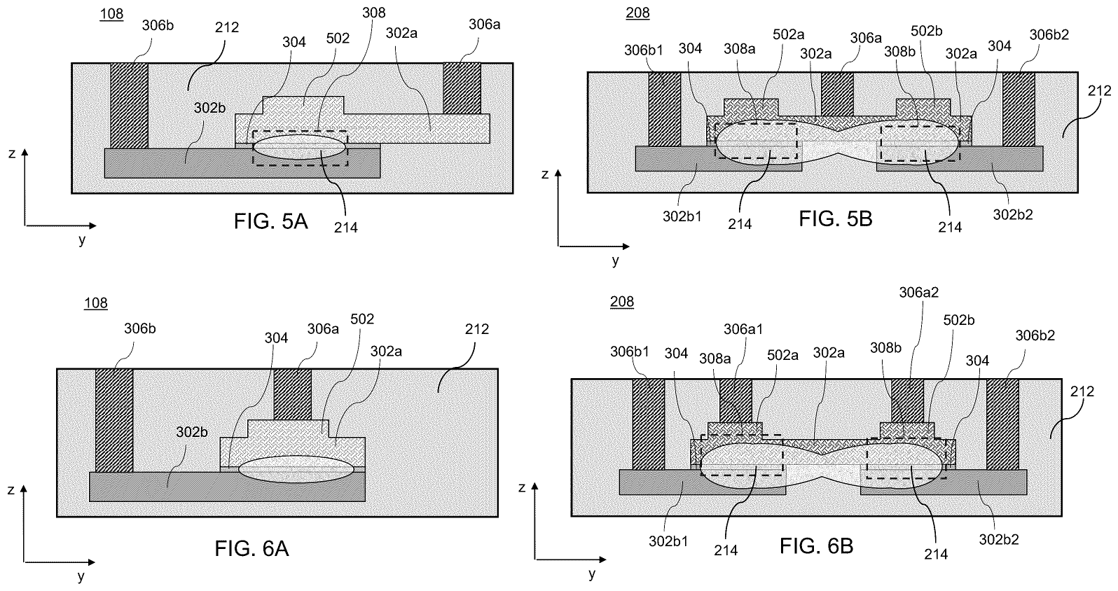

FIGS. 5A, 5B, 6A, and 6B are vertical cross-sectional views of alternative modulator portions 108 and alternative photonic couplers 208, according to various embodiments. The modulator portion 108 of FIG. 5A may be similar to the modulator portion 108 of FIG. 3B. In contrast to the modulator portion 108a of FIG. 3B, however, the first terminal 302a may be configured to include a ridge waveguide structure 502. The ridge waveguide structure 502 may be configured to confine the electromagnetic field distribution 214 to be more localized than the corresponding electromagnetic field distribution 214 of the modulator portion 108a of FIG. 3B. As such, the coupling waveguide segment 308 of the modulator portion 108 of FIG. 5A may have a spatial extent in the width direction (i.e., the y-direction) that is less than that of the modulator portion 108 of FIG. 3B.

As shown in FIG. 5B, the first terminal 302a of the photonic coupler 208 may include a first ridge waveguide structure 502a and a second ridge waveguide structure 502b. Each of the first ridge waveguide structure 502a and a second ridge waveguide structure 502b may be configured to achieve a predetermined spatial profile of the electromagnetic field distribution 214 within each of the first coupling waveguide segment 308a and the second coupling waveguide segment 308b, respectively. As with the photonic coupler 208a of FIG. 5A, the first segment 302b1 and the second segment 302b2 of the second terminal (302b1, 302b2) may be physically separated from one another, but may be sufficiently close to one another such that the respective electromagnetic field distributions 214 are overlapping with one another. In this regard, evanescent fields from each of the first segment 302b1 and the second segment 302b2 may overlap with one another such that evanescent coupling between the first coupling waveguide segment 308a and the second coupling waveguide segment 308b may occur, as described in greater detail with reference to FIG. 2B, above.

As shown in FIGS. 6A and 6B, the alternative modulator portion 108 and photonic coupler 208 may have different respective configurations of electrical contacts. For example, as shown in FIG. 6A, the first electrical contact 306a may be formed to be directly in contact with the ridge waveguide structure 502. Similarly, the alterative photonic coupler 208 may have a first electrical contact 306a1 and a second electrical contact 306a2, in contrast to the single electrical contact 306a of the photonic coupler 208 of FIG. 3C. As shown in FIG. 6B, the first electrical contact 306a1 and the second electrical contact 306a2 may be respectively connected to the first ridge waveguide structure 502a and the second ridge waveguide structure 502b. Various other configurations of the first terminal 302a, the second terminal (302b, 302b1, 302b2), and the electrical contacts (306a, 306a1, 306a2, 306b1, 306b2) may be provided in other embodiments.

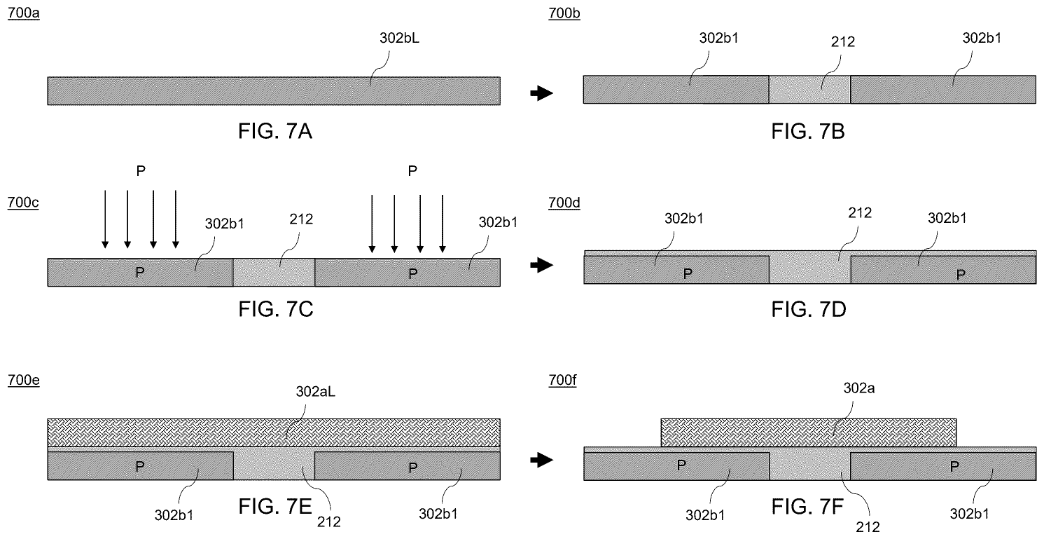

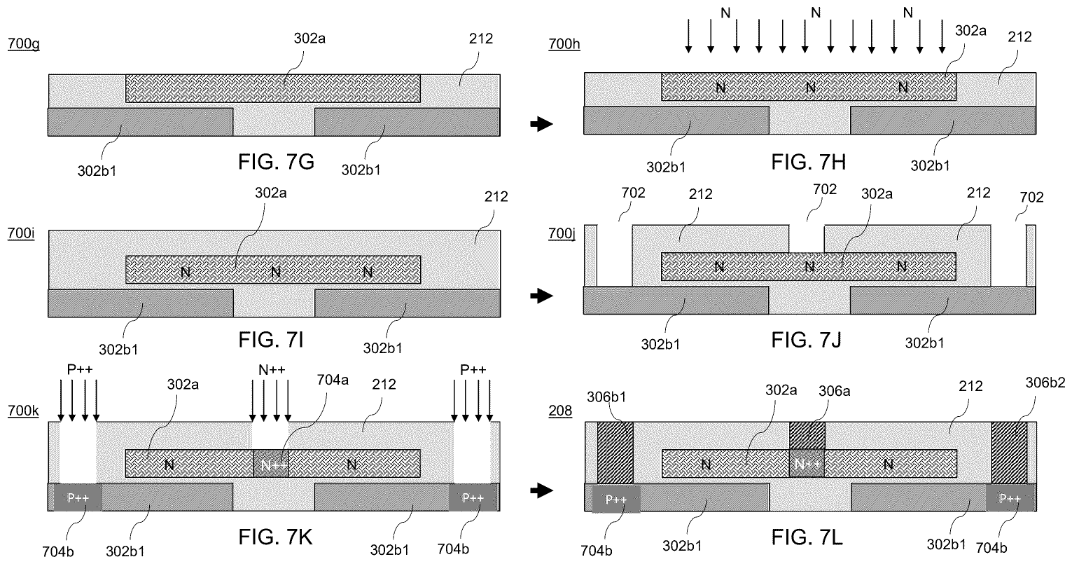

FIGS. 7A to 7K are vertical cross-sectional views of intermediate structures (700a to 700k) that may be used in the formation of a photonic coupler 208, as shown in FIG. 7L, according to various embodiments. The intermediate structure 700a may include a layer 302bL of a semiconductor material that may be used to form the second terminal (302b1, 302b2). For example, the layer 302bL may be a topmost layer of a silicon substrate, or a silicon layer of a silicon-on-insulator substrate. The layer 302bL may be undoped or may be a p-type doped layer 302bL. The intermediate structure 700b of FIG. 7B may be formed from the intermediate structure 700a of FIG. 7A by etching the layer 302bL to remove a portion of the layer 302bL. The resulting intermediate structure 700b may include the separated first segment 302b1 and the second segment 302b2 of the second terminal (302b1, 302b2). In this regard, a patterned photoresist (not shown) may be formed over the semiconductor layer 302bL to mask regions corresponding to the non-etched regions forming the first segment 302b1 and the second segment 302b2 of the second terminal (302b1, 302b2). A non-masked central region may then be etched by performing an anisotropic etch process. The patterned photoresist may then be removed by ashing or by dissolution with a solvent.

A cladding material may then be formed in the region that was etched from the layer 302bL. As such, a cladding portion 212 may be formed. The cladding portion 212 may be formed by depositing a dielectric material followed by performing a planarization processes (such as chemical mechanical planarization (CMP)). In an example embodiment, the cladding portion 212 may include silicon oxide. Other embodiments may include other oxides or other types of dielectric materials such as polymers. The intermediate structure 700c of FIG. 7C may be formed from the intermediate structure 700b of FIG. 7B by selectively doping to the first segment 302b1 and the second segment 302b2 of the second terminal (302b1, 302b2). In this regard, an ion implantation process may be performed to introduce p-type dopants into the first segment 302b1 and the second segment 302b2 of the second terminal (302b1, 302b2). Additional dielectric material may then be deposited over the resulting structure to form the intermediate structure 700d of FIGS. 7D. In this regard, after deposition of addition dielectric material, a planarization process (such as CMP) may be performed to thereby form a flat surface to the cladding portion 212.

The intermediate structure 700e of FIG. 7E may be formed from the intermediate structure 700d of FIG. 7D by deposition of a further semiconductor layer 302aL over a top surface of the cladding portion 212. In this regard, the semiconductor layer 302aL may be a semiconductor material that may be suitable for formation of the first terminal 302a. For example, in certain embodiments, the semiconductor layer 302aL may be polysilicon that may be deposited using a conformal deposition method, such as chemical vapor deposition (CVD). Other embodiments may include other semiconductor layers 302aL that may be suitable for formation of the first terminal 302a that may be deposited using suitable respective methods.

The intermediate structure 700f of FIG. 7F may be formed from the intermediate structure 700e of FIG. 7E by performing an etching operation to remove portions of the semiconductor layer 302aL. The remaining intermediate structure 700f may include the first terminal 302a. In this regard, a patterned photoresist (not shown) may be formed over the semiconductor layer 302aL to mask a region corresponding to the non-etched region forming the first terminal 302a. Non-masked regions may then be etched by performing an anisotropic etch process. The patterned photoresist may then be removed by ashing or by dissolution with a solvent. The intermediate structure 700g of FIG. 7G may be formed from the intermediate structure 700f of FIG. 7F by deposition of additional dielectric material to increase a thickness of the cladding portion 212. A planarization process (e.g., CMP) may then be performed to remove a top surface of the additional dielectric layer over a top surface of the first terminal 302a to thereby expose the top surface of the first terminal 302a. The intermediate structure 700h of FIG. 7H may be formed from the intermediate structure 700g of FIG. 7G by performing a selective doping process, for example, using ion implantation to thereby introduce n-type dopants into the first terminal 302a.

The intermediate structure 700i of FIG. 7I may be formed from the intermediate structure 700h of FIG. 7H by deposition of additional dielectric material, such as silicon oxide, over the intermediate structure 700h to thereby increase a thickness of the cladding portion 212. A planarization process (e.g., CMP) may then be performed to remove a portion of the additional dielectric layer and to thereby form a flat top surface to the cladding portion and to expose a top surface of the first terminal 302a. The intermediate structure 700j of FIG. 7J may be formed from the intermediate structure 700i of FIG. 7I by performing an etching process to thereby generate contact via openings 702 in the cladding portion 212.

In this regard, a patterned photoresist (not shown) may be formed over the top surface of the intermediate structure 700i using lithographic techniques. The patterned photoresist may then be used as an etch mask to protect portions of the surface of the cladding portion 212 that are not to be etched. The un-masked portions of the patterned photomask may correspond to regions that will be etched to form the contact via openings 702. As shown, the etching process may be performed until top surfaces of the first terminal 302a, the first segment 302b1, and the second segment 302b2 of the second terminal (302b1, 302b2) are exposed

The intermediate structure 700k of FIG. 7K may be formed from the intermediate structure 700j of FIG. 7J by performing selective doping processes to generate an n-well 704a and p-wells 704b. In this regard, a first ion-implantation process may be performed to introduce additional n-type dopants into the first terminal 302a through a corresponding via opening 702 to thereby form the n-well 704a. Similarly, a second ion-implantation process may be performed to introduce additional p-type dopants into the first segment 302b1 and the second segment 302b2 of the second terminal (302b1, 302b2) through corresponding via openings 702 to thereby form the p-wells.

The photonic coupler 208 of FIG. 7L may then be formed from the intermediate structure 700k of FIG. 7K by deposition of a conductive material in the contact via openings 702 to thereby form the first electrical contact 306a, the second electrical contact 306b1, and the third electrical contact 306b2. In this regard, the conductive material may be a combination of a metallic liner (such as a metallic nitride or a metallic carbide) and a metallic fill material. Each metallic liner may include TiN, TaN, WN, TiC, TaC, and WC, and each metallic fill material portion may include W, Cu, Al, Co, Ru, Mo, Ta, Ti, alloys thereof, and/or combinations thereof. Other suitable metallic liner and metallic fill materials within the contemplated scope of disclosure may also be used. A planarization process (e.g., CMP) may then be performed to remove a remaining portion of the conductive material over a top surface of the cladding portion 212.

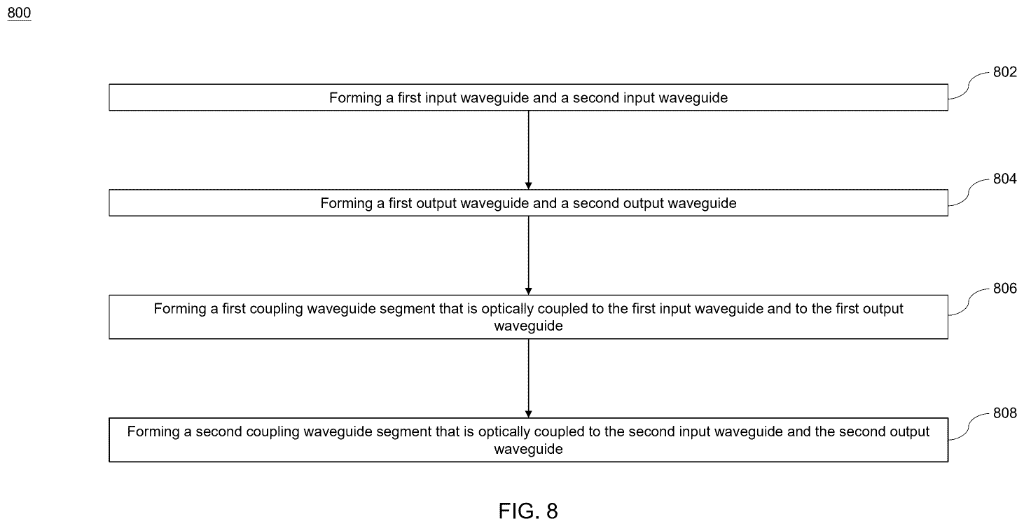

FIG. 8 is a flowchart illustrating operations of a method 800 of forming a photonic coupler (208, 208a, 208b), according to various embodiments. In operation 802, the method 800 may include forming a first input waveguide 104a1 and a second input waveguide 104a2. In operation 804, the method 800 may include forming a first output waveguide 104b1 and a second output waveguide 104b2. As described in greater detail below, in operations 806 and 808, the method 800 may include forming a coupling region 209 including an electro-optic device (302a, 304, 302b) that may include an index of refraction that is a function of an applied voltage, such that electromagnetic fields associated with two or more of the first input waveguide 104a1, the second input waveguide 104a2, the first output waveguide 104b1, and the second output waveguide 104b2 are overlapping with one another in the coupling region 209.

In this regard, according to operation 806, the method 800 may further include forming a first coupling waveguide segment 308a that is optically coupled to the first input waveguide 104a1 and to the first output waveguide 104b1. According to operation 808, the method 800 may further include forming a second coupling waveguide segment 308b that is optically coupled to the second input waveguide 104a2 and the second output waveguide 104b2. Operations 806 and 808 of the method 800 may be performed such that each of the first coupling waveguide segment 308a and the second coupling waveguide segment 308b includes the electro-optic device (302a, 304, 302b).

In forming coupling region 209 including the electro-optic device (302a, 304, 302b), the method 800 may further include forming a first terminal 302a that includes n-type polysilicon, forming a second terminal (302b1, 302b2) that includes p-type silicon, and forming a dielectric layer 304 separating the first terminal 302a from the second terminal (302b1, 302b2). Alternatively, in other embodiments, the method 800 may further include forming the first terminal 302a to include p-type polysilicon and forming the second terminal (302b1, 302b2) to include n-type silicon. The method 800 may further include forming the first coupling waveguide segment 308a to extend along a length direction (i.e., the x-direction), which is parallel to an optical propagation direction, such that the first coupling waveguide segment 308a is formed as a first overlap region 308a in which the first terminal 302a, the second terminal (302b1, 302b2), and the dielectric layer 304 are overlapping in a plan view along a thickness direction (i.e., the z-direction) that is perpendicular to the length direction (i.e., the x-direction),

The method 800 may further include forming the second coupling waveguide segment 308b to extend along the length direction (i.e., the x-direction), such that the second coupling waveguide segment 308b is formed as a second overlap region 308b in which the first terminal 302a, the second terminal (302b1, 302b2), and the dielectric layer 304 are overlapping in the plan view along the thickness direction (i.e., the z-direction). The method 800 may further include forming the first coupling waveguide segment 308a and the second coupling waveguide segment 308b to be separated from one another along a width direction (i.e., the y-direction) that is perpendicular to the length direction (i.e., the x-direction) and the thickness direction (i.e., the z-direction). In certain embodiments, the method 800 may include forming the first coupling waveguide segment 308a and the second coupling waveguide segment 308b to include respective ridge waveguide structures (502a, 502b).

Referring to all drawings and according to various embodiments of the present disclosure, a photonic coupler (208, 208a, 208b) is provided. The photonic coupler (208, 208a, 208b) may include a first input waveguide 104a1 and a second input waveguide 104a2, a first output waveguide 104b1 and a second output waveguide 104b2, and a coupling region 209. The coupling region 209 may be formed such that electromagnetic fields associated with two or more of the first input waveguide 104a1, the second input waveguide 104a2, the first output waveguide 104b1, and the second output waveguide 104b2 are overlapping with one another.

The photonic coupler (208, 208a, 208b) may further include an electro-optic device (302a, 304, 302b) in the coupling region 209 including an index of refraction that is a first function of an applied voltage. The coupling region 209 may include an effective coupling length, along an optical propagation direction, which is a second function of a product of a physical length of the coupling region 209 multiplied by the index of refraction of the electro-optic device (302a, 304, 302b). In this regard, the effective coupling length may be a function of the applied voltage because the effective coupling length depends on the index of refraction of the electro-optic device (302a, 304, 302b). Further, according to various embodiments, the effective coupling length may be voltage-tunable to be an integer multiple of a wavelength plus a quarter wavelength.

In various embodiments, a first percentage of a first electromagnetic energy may be coupled from the first input waveguide 104a1 into the second output waveguide 104b2 and a second percentage of a second electromagnetic energy is coupled from the second input waveguide 104a2 into the first output waveguide 104b1, such that the first percentage of the first electromagnetic energy and the second percentage of the second electromagnetic energy are functions of the applied voltage. In certain embodiments, each of the first percentage and the second percentage may be between 41% and 59%. The effective coupling length may be increased when the applied voltage has a first polarity and may be decreased when the applied voltage has a second polarity that is opposite to the first polarity.

In various embodiments, the electro-optic device (302a, 304, 302b) may include a first terminal 302a including a first semiconductor material doped with first-conductivity-type dopant, a second terminal (302b1, 302b2) including a second semiconductor material doped with a second-conductivity-type dopant, and a dielectric layer 304 separating the first terminal 302a from the second terminal (302b1, 302b2). In certain embodiments, the dielectric layer 304 may include silicon oxide, the first terminal 302a may include n-type polysilicon, and the second terminal (302b1, 302b2) may include p-type silicon. Alternatively, in other embodiments, the first terminal 302a may include p-type polysilicon and the second terminal 302b may include n-type silicon. The coupling region 209 further may include a first coupling waveguide segment 308a, which is optically coupled to the first input waveguide 104a1 and to the first output waveguide 104b1, and a second coupling waveguide segment 308b, which is optically coupled to the second input waveguide 104a2 and the second output waveguide 104b2.

The first coupling waveguide segment 308a may extend along a length direction (i.e., the x-direction), which is parallel to an optical propagation direction, and may be formed as a first overlap region 308a in which the first terminal 302a, the second terminal (302b1, 302b2), and the dielectric layer 304 are overlapping in a plan view along a thickness direction (i.e., the z-direction) that is perpendicular to the length direction (i.e., the x-direction). The second coupling waveguide segment 308b may extend along the length direction (i.e., the x-direction) and may be formed as a second overlap region 308b in which the first terminal 302a, the second terminal (302b1, 302b2), and the dielectric layer 304 are overlapping in the plan view along the thickness direction (i.e., the z-direction). Further, the first coupling waveguide segment 308a and the second coupling waveguide segment 308b may be separated from one another along a width direction (i.e., the y-direction) that is perpendicular to the length direction (i.e., the x-direction) and the thickness direction (i.e., the z-direction).

According to various embodiments, the first terminal 302a may include a first slab geometry extending along the length direction (i.e., the x-direction), the width direction (i.e., the y-direction), and the thickness direction (i.e., the z-direction); and the second terminal (302b1, 302b2) may include a first segment 302b1 and a second segment 302b2 that are disconnected from one another. Each of the first segment 302b1 and the second segment 302b2 include a second slab geometry extending along the length direction (i.e., the x-direction), the width direction (i.e., the y-direction), and the thickness direction (i.e., the z-direction) and such that the first segment 302b1 and the second segment 302b2 are separated from one another along the width direction (i.e., the y-direction). The first terminal 302a may be electrically connected to a first electrical contact 306a, the first segment 302b1 of the second terminal (302b1, 302b2) may be electrically connected to a second electrical contact 306b1, and the second segment 302b2 of the second terminal (302b1, 302b2) may be electrically connected to a third electrical contact 306b2.

Further, referring to all drawings and according to various embodiments of the present disclosure, a photonic device (300, 400) is provided. The photonic device (300, 400) may include a first input waveguide 104a1, a second input waveguide 104a2, a third input waveguide 104a3, a fourth input waveguide 104a4, a first output waveguide 104b1, a second output waveguide 104b2, a third output waveguide 104b3, and a fourth output waveguide 104b4. The photonic device (300, 400) may further include a first photonic coupler 208a that mixes a first input photonic signal received from the first input waveguide 104a1 and a second input photonic signal received from the second input waveguide 104a2 to generate a first output photonic signal and a second output photonic signal that are respectively provided to the first output waveguide 104b1 and the second output waveguide 104b2. The photonic device (300, 400) may further include a second photonic coupler 208b that mixes a third input photonic signal received from the third input waveguide 104a3 and a fourth input photonic signal received from the fourth input waveguide 104a4 to generate a third output photonic signal and a fourth output photonic signal that are respectively provided to the third output waveguide 104b3 and the fourth output waveguide 104b4.

The photonic device (300, 400) may further include a first modulator portion 108a that changes a first amplitude or phase of the first output photonic signal to generate the third input photonic signal that is provided to the second input waveguide 104a2. In this regard, at least one of the first photonic coupler 208a and the second photonic coupler 208b includes an electro-optic device (302a, 304, 302b) that determines a mixing ratio of the first input photonic signal and the second input photonic signal, or of the third input photonic signal and the fourth input photonic signal, based on an applied voltage imposed on the first photonic coupler 208a or the second photonic coupler 208b, respectively. In certain embodiment, the first output waveguide 104b1 may be photonically coupled to the fourth input waveguide 104a4. In other embodiments, the photonic device (300, 400) may further include a second modulator portion 108b that changes an amplitude or phase of the second output photonic signal, received from the second output waveguide 104b2, to generate the fourth input photonic signal that is provided to the fourth input waveguide 104a4.

In still further embodiments, the photonic device (300, 400) may include at least one additional modulator portion (108c, 108d) that controls an amplitude or phase of the first input photonic signal or the second input photonic signal. In various embodiments, the first photonic coupler 208a and the second photonic coupler 208b may determine respective mixing ratios of input signals to generate respective output signals such that the respective mixing ratios are functions of voltages applied respectively to the first photonic coupler 208a and the second photonic coupler 208b.

As described above, disclosed embodiments include an embodiment photonic coupler (208, 208a, 208b) that may be advantageous by providing an electro-optic device (302a, 304, 302b) that allows an effective coupling length to be tuned based on a voltage that is applied to the electro-optic device (302a, 304, 302b). In this regard, the effective coupling length may determine a mixing ratio of first electromagnetic energy transferred from a first input waveguide 104a1 to a second output waveguide 104b2 relative to second electromagnetic energy transferred from a second input waveguide 104a2 to a first output waveguide 104b1. For example, the embodiment photonic coupler (208, 208a, 208b) may be designed to perform as a 50/50 beam splitter in the absence of an applied voltage, by designing the effective coupling length to be an integer multiple of a wavelength plus a quarter wavelength. Due to manufacturing tolerances, however, there may be imperfections in the photonic coupler (208, 208a, 208b) that may lead to errors in the mixing ratio of transferred electromagnetic energy.

Thus, while designed as a 50/50 beam splitter, the photonic coupler (208, 208a, 208b) may actually perform as a 49/51 beam splitter (or a 41/59 beam splitter, etc.), for example, due to imperfections. By providing the electro-optic device (302a, 304, 302b), however, the mixing ratio may be corrected with a suitably applied bias voltage. In this regard, the bias voltage may be used to correct the 49/51 performance (or other percentage error) to achieve the desired 50/50 beam splitter performance by tuning the voltage-dependent effective coupling length. In other embodiments, the electro-optic device (302a, 304, 302b) may be used to achieve various other mixing ratios in other applications. As such, the embodiment photonic coupler (208, 208a, 208b) may allow errors in device performance to be easily corrected by adjusting the applied voltage.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure

What is claimed is:

1. A photonic coupler, comprising:
a first input waveguide and a second input waveguide;
a first output waveguide and a second output waveguide;
a coupling region in which electromagnetic fields associated with two or more of the first input waveguide, the second input waveguide, the first output waveguide, and the second output waveguide overlap; and
an electro-optic device in the coupling region comprising an index of refraction that is a first function of an applied voltage.

2. The photonic coupler of claim 1, wherein the coupling region comprises an effective coupling length, along an optical propagation direction, which is a second function of a product of a physical length of the coupling region multiplied by the index of refraction of the electro-optic device.

3. The photonic coupler of claim 2, wherein the effective coupling length is a function of the applied voltage and depends on the index of refraction of the electro-optic device, and
wherein the effective coupling length is voltage-tunable to be an integer multiple of a wavelength plus a quarter wavelength.

4. The photonic coupler of claim 3, wherein a first percentage of a first electromagnetic energy is coupled from the first input waveguide into the second output waveguide and a second percentage of a second electromagnetic energy is coupled from the second input waveguide into the first output waveguide, and
wherein the first percentage of the first electromagnetic energy and the second percentage of the second electromagnetic energy are functions of the applied voltage.

5. The photonic coupler of claim 4, wherein each of the first percentage and the second percentage is between 41% and 59%.

6. The photonic coupler of claim 2, wherein the effective coupling length is increased when the applied voltage comprises a first polarity and is decreased when the applied voltage comprises a second polarity that is opposite to the first polarity.

7. The photonic coupler of claim 1, wherein the electro-optic device comprises:
a first terminal comprising a first semiconductor material doped with first-conductivity-type dopant;
a second terminal comprising a second semiconductor material doped with a second-conductivity-type dopant; and
a dielectric layer separating the first terminal from the second terminal.

8. The photonic coupler of claim 7, wherein:
the first terminal comprises n-type polysilicon;
the second terminal comprises p-type silicon; and
the dielectric layer comprises silicon oxide.

9. The photonic coupler of claim 7, wherein the coupling region further comprises:
a first coupling waveguide segment that is optically coupled to the first input waveguide and to the first output waveguide; and
a second coupling waveguide segment that is optically coupled to the second input waveguide and the second output waveguide,
wherein the first coupling waveguide segment extends along a length direction, which is parallel to an optical propagation direction, and is formed as a first overlap region in which the first terminal, the second terminal, and the dielectric layer are overlapping in a plan view along a thickness direction that is perpendicular to the length direction,
wherein the second coupling waveguide segment extends along the length direction and is formed as a second overlap region in which the first terminal, the second terminal, and the dielectric layer are overlapping in the plan view along the thickness direction, and
wherein the first coupling waveguide segment and the second coupling waveguide segment are separated from one another along a width direction that is perpendicular to the length direction and the thickness direction.

10. The photonic coupler of claim 9, wherein:
the first terminal comprises a first slab geometry extending along the length direction, the width direction, and the thickness direction; and
the second terminal comprises a first segment and a second segment that are disconnected from one another, wherein each of the first segment and the second segment comprise a second slab geometry extending along the length direction, the width direction, and the thickness direction,
wherein the first segment and the second segment are separated from one another along the width direction.

11. The photonic coupler of claim 10, wherein:
the first terminal is electrically connected to a first electrical contact;
the first segment of the second terminal is electrically connected to a second electrical contact; and
the second segment of the second terminal is electrically connected to a third electrical contact.

12. A photonic device, comprising:
a first input waveguide, a second input waveguide, a third input waveguide, and a fourth input waveguide;
a first output waveguide, a second output waveguide, a third output waveguide, and a fourth output waveguide;
a first photonic coupler that mixes a first input photonic signal received from the first input waveguide and a second input photonic signal received from the second input waveguide to generate a first output photonic signal and a second output photonic signal that are respectively provided to the first output waveguide and the second output waveguide;
a second photonic coupler that mixes a third input photonic signal received from the third input waveguide and a fourth input photonic signal received from the fourth input waveguide to generate a third output photonic signal and a fourth output photonic signal that are respectively provided to the third output waveguide and the fourth output waveguide; and
a first modulator portion that changes a first amplitude or phase of the first output photonic signal to generate the third input photonic signal that is provided to the second input waveguide,
wherein at least one of the first photonic coupler and the second photonic coupler comprises an electro-optic device that determines a mixing ratio of the first input photonic signal and the second input photonic signal, or of the third input photonic signal and the fourth input photonic signal, based on an applied voltage imposed on the first photonic coupler or the second photonic coupler, respectively.

13. The photonic device of claim 12, wherein the first output waveguide is photonically coupled to the fourth input waveguide.

14. The photonic device of claim 12, further comprising:
a second modulator portion that changes an amplitude or phase of the second output photonic signal that is received from the second output waveguide to generate the fourth input photonic signal that is provided to the fourth input waveguide.

15. The photonic device of claim 12, further comprising:
at least one additional modulator portion that controls an amplitude or phase of the first input photonic signal or the second input photonic signal.

16. The photonic device of claim 12, wherein the first photonic coupler and the second photonic coupler determine respective mixing ratios of input signals to generate respective output signals such that the respective mixing ratios are functions of voltages applied respectively to the first photonic coupler and the second photonic coupler.

17. A method of forming a photonic coupler, comprising:
forming a first input waveguide and a second input waveguide;
forming a first output waveguide and a second output waveguide; and
forming a coupling region comprising an electro-optic device that comprises an index of refraction that is a function of an applied voltage,
wherein electromagnetic fields associated with two or more of the first input waveguide, the second input waveguide, the first output waveguide, and the second output waveguide overlap one another in the coupling region.

18. The method of claim 17, wherein forming the coupling region further comprises:
forming a first coupling waveguide segment that is optically coupled to the first input waveguide and to the first output waveguide; and
forming a second coupling waveguide segment that is optically coupled to the second input waveguide and the second output waveguide,
wherein each of the first coupling waveguide segment and the second coupling waveguide segment comprises the electro-optic device.

19. The method of claim 18, wherein forming the coupling region further comprises:
forming a first terminal comprising n-type polysilicon;
forming a second terminal comprising p-type silicon; and
forming a dielectric layer separating the first terminal from the second terminal.

20. The method of claim 19, further comprising:
forming the first coupling waveguide segment to extend along a length direction, which is parallel to an optical propagation direction, such that the first coupling waveguide segment is formed as a first overlap region in which the first terminal, the second terminal, and the dielectric layer are overlapping in a plan view along a thickness direction that is perpendicular to the length direction,
forming the second coupling waveguide segment to extend along the length direction, such that the second coupling waveguide segment is formed as a second overlap region in which the first terminal, the second terminal, and the dielectric layer are overlapping in the plan view along the thickness direction, and
forming the first coupling waveguide segment and the second coupling waveguide segment to be separated from one another along a width direction that is perpendicular to the length direction and the thickness direction, and such that the first coupling waveguide segment and the second coupling waveguide segment include a ridge waveguide structure.
